(19) United States
(12) Patent Application Publication
(10) Pub. No.: US 2007/0230222 A1
(43) Pub. Date: Oct. 4, 2007

(54) Power circuitry for high-frequency applications

(76) Inventors: Richard B. Drabing, Los Altos, CA (US); Matthew Kurt Senesky, Berkeley, CA (US)

Correspondence Address: LEVINE BAGADE HAN LLP, 2483 EAST BAYSHORE ROAD, SUITE 100, PALO ALTO, CA, 94303, US

(21) Appl. No.: 11/394,659

(22) Filed: Mar. 31, 2006

(51) Int. Cl. H02M 3/335

(52) U.S. Cl. 363/21.01

(57) ABSTRACT

The present the invention provides power circuitry for the charging and discharging of high-frequency devices.

### FIELD OF THE INVENTION

The present invention is related to power circuitry for the charging and discharging of devices at high frequencies. The power circuitry of the present invention is particularly suitable for high-voltage applications, with one particular application being electroactive polymer transducer devices.

### BACKGROUND

A tremendous variety of devices used today rely on actuators of one sort or another to convert electrical energy to mechanical energy. The actuators “give life” to these products, putting them in motion. Conversely, many power generation applications operate by converting mechanical action into electrical energy.

Employed to harvest mechanical energy in this fashion, the same type of actuator may be referred to as a generator. Likewise, when the structure is employed to convert physical stimulus such as vibration or pressure into an electrical signal for measurement purposes, it may be referred to as a transducer. Yet, the term “transducer” may be used to generically refer to any of the devices.

Especially for actuator and generator applications, a number of design considerations favor the selection and use of advanced electroactive polymer technology based transducers. These considerations include force, power density, power conversion/consumption, size, weight, cost, response time, duty cycle, service requirements, environmental impact, etc. Electroactive Polymer Artificial Muscle (EPAM™) technology developed by SRI International and licensee Artificial Muscle, Inc. excels in each of these categories relative to other available technologies. In many applications, EPAM™ technology offers an ideal replacement for piezoelectric, shape-memory alloy (SMA) and electromagnetic devices such as motors and solenoids.

As an actuator, EPAM™ technology operates by application of a voltage across two thin elastic film electrodes separated by an elastic dielectric polymer (e.g., made of acrylic, silicone, or the like). When a voltage difference is applied to the electrodes, the oppositely-charged members attract each other producing pressure upon the polymer therebetween. The pressure pulls the electrodes together, causing the dielectric polymer film to become thinner (the z-axis component shrinks) as it expands in the planar directions (the x- and y-axes of the polymer film grow). Another factor drives the thinning and expansion of the polymer film. The like (same) charge distributed across each elastic film electrode causes the conductive particles embedded within the film to repel one another expanding the elastic electrodes and dielectric attached polymer film.

Using this “shape-shifting” technology, Artificial Muscle, Inc. is developing a family of new solid-state devices for use in a wide variety of industrial, medical, consumer, and electronics applications. Current product architectures include: actuators, motors, transducers, sensors, pumps, and generators. Actuators, motors and pumps are enabled by the action discussed above. Generators are enabled by reversing the action described above, and sensors are enabled by virtue of changing capacitance upon physical deformation of the material. Examples of such EPAM actuators and their applications are described in the following patents, published patent applications and/or pending patent applications:
U.S. Pat. No. 6,940,221 Electroactive polymer transducers and actuators
U.S. Pat. No. 6,911,764 Energy Efficient Electroactive Polymers and Electroactive Polymer Devices
U.S. Pat. No. 6,891,317 Rolled Electroactive Polymers
U.S. Pat. No. 6,882,086 Variable Stiffness Electroactive Polymer Systems
U.S. Pat. No. 6,876,135 Master/slave Electroactive Polymer Systems
U.S. Pat. No. 6,812,624 Electroactive polymers
U.S. Pat. No. 6,809,462 Electroactive polymer sensors
U.S. Pat. No. 6,806,621 Electroactive polymer rotary motors
U.S. Pat. No. 6,781,284 Electroactive polymer transducers and actuators
U.S. Pat. No. 6,768,246 Biologically powered electroactive polymer generators
U.S. Pat. No. 6,707,236 Non-contact electroactive polymer electrodes
U.S. Pat. No. 6,664,718 Monolithic electroactive polymers
U.S. Pat. No. 6,628,040 Electroactive polymer thermal electric generators
U.S. Pat. No. 6,586,859 Electroactive polymer animated devices
U.S. Pat. No. 6,583,533 Electroactive polymer electrodes
U.S. Pat. No. 6,545,384 Electroactive polymer devices
U.S. Pat. No. 6,543,110 Electroactive polymer fabrication
U.S. Pat. No. 6,376,971 Electroactive polymer electrodes
U.S. Pat. No. 6,343,129 Elastomeric dielectric polymer film sonic actuator
2006/0000214 Compliant walled combustion devices
2005/0157893 Surface deformation electroactive polymer transducers
20040263028 Electroactive polymers
20040217671 Rolled electroactive polymers
20040124738 Electroactive polymer thermal electric generators
20040046739 Pliable device navigation method and apparatus
20040008853 Electroactive polymer devices for moving fluid
20030214199 Electroactive polymer devices for controlling fluid flow
20020175598 Electroactive polymer rotary clutch motors
20020122561 Elastomeric dielectric polymer film sonic actuator
   Each of these documents is incorporated herein by reference in its entirety for the purpose of providing background and/or further detail regarding underlying technology and features as may be used in connection with or in combination with the aspects of present invention set forth herein.

As illustrated in many of the above-identified patent documents, EPAM™-based, diaphragm-type actuators are made by extending the polymer film over an opening in a rigid frame or structure. Also described in some of these documents is the use of pre-straining the film to increase the performance capabilities, e.g., frequency output, of the actuators. Stretching or pre-straining certain kinds of EPAM film improves the dielectric strength of the polymer, thereby offering improvement for conversion between electrical and mechanical energy by allowing higher field potentials.

U.S. patent application Ser. Nos. 11/361,703; 11/361,676; 11/361,683; and 11/361,704, incorporated herein by reference in their entirety, disclose the practice of biasing the EPAM actuators to improve actuator performance. Specifically, biasing, i.e., pushing or weighting the diaphragm in a selected direction, has been found to insure that the diaphragm will move in the direction of the bias upon electrode activation/thickness contraction rather than simply wrinkling. Biasing can be accomplished by use of a cap, spring, a rod or plunger, resilient foam, fluid pressure, or another EPAM diaphragm.

Many of these EPAM™ transducers are operable at frequencies ranging from DC up to 10 kHz or more, thereby allowing overall device power output to be maximized for a given application. As EPAM transducers are mostly capacitive in nature, when actuated (charged), the EPAM transducer stores energy in an electric field between two electrodes. That energy needs to be removed (discharged) in order to return the EPAM transducer to its rest position. Thus, when the transducers are run at high frequencies, rapid charging and discharging of high voltages is required. In practice, the charging portion of the process does not present a significant challenge—many commercially available switching power supplies perform this function. However, the assignee of the present invention is not aware of a previous solution to the problem of efficiently discharging a capacitor charged to high voltage that is practical over a wide frequency range.

One approach to the problem of discharging high voltages involves the use of resistive devices, such as a fixed resistor or a switch, that dissipate the stored energy as heat. This is undesirable in terms of efficiency and device heating. In theory, a high-frequency switched circuit of the type used for charging can be used for discharging as well. However, a necessary component of such a circuit is a semiconductor switching element that can withstand at least the maximum transducer voltage. The assignee of the present invention is not aware of a commercially available semiconductor device that meets the voltage, size, and cost constraints for such high-frequency/high-voltage application.

Cascading (series connection) of multiple switch devices to reach a desired voltage rating is possible, but significant numbers of parts must be added in addition to the main power devices, possibly including high voltage drive transformers with difficult isolation requirements. Assuming such a sub-circuit can be constructed, providing the gate or base drive necessary to turn on the switch can be problematic. If the switch is “floating” (i.e., not referenced to ground), the low-voltage drive signal must be supplied on top of a common mode voltage level close to the high voltage appearing across the transducer.

An additional concern for the switching of high voltages is power dissipation due to parasitic capacitances connected to the switching node. When the switching node is held at high voltage (switch off), any parasitic capacitances associated with that node are charged to high voltage, storing a significant amount of energy. Because the stored energy is proportional to the square of the voltage (E=½CV²), even a small capacitance can store a relatively large amount of energy at high voltage. If the switch is turned on with the full voltage across it, all of this stored energy is dissipated as heat. In a fast switching circuit, this energy is dissipated in the transistor switch at every turn-on, and can result in a substantial amount of power being dissipated in the transistor itself. This effect is one component of what is commonly referred to as switching loss. The effect is particularly acute in high voltage circuits, where losses due to high-frequency switching activity can quickly reach unacceptable levels. In addition to reducing efficiency, these losses can increase the temperature of the switching elements beyond their ratings, causing premature failure.

In sum, these exemplary approaches involve significant energy dissipation, and can result in the inefficient transfer of electrical energy into mechanical motion, causing poor battery life and requiring additional thermal management measures.

Another approach to high voltage discharging involves coupling the transducer directly to a transformer. The transformer approach allows the high transducer voltage to be stepped down by the transformer turn ratio such that charging and discharging can be accomplished at low voltages. However, the size of the required transformer increases as the frequency of the charge/discharge cycle decreases. Thus, for the majority of applications in which weight, size and mass considerations are essential (e.g., applications for which EPAM transducers are extremely suitable), the required transformer is unacceptably large.

Thus, there continues to be an interest and need in developing power circuitry for high-performance transducers, such as EPAM-based transducers. The present invention overcomes the limitations of known power supplies, particularly those implementing flyback converter circuits, and offers power circuitry for improving the power output capabilities of such high-frequency/high voltage devices.

### SUMMARY OF THE INVENTION

The present invention includes novel circuitry and methods for powering high-performance devices, such as EPAM-based transducers and other high-frequency/high-voltage devices. In particular, the power circuitry of the present invention includes flyback converter circuits with bi-directional energy transfer and synchronous switching capabilities. The subject power circuitry may be used in conjunction with a control circuit of the present invention, both of which may be incorporated into a packaged power supply. The methods of the present invention include charging and discharging a load with high efficiency and minimum power loss, where the load is representative of a high-frequency device, such as an EPAM transducer.

Various features and advantages of the present invention include but are not limited to the following: (1) the same components in a single circuit are used for both charging and discharging of a capacitive device; (2) there are no inherent restrictions on the minimum charge/discharge frequency of the device being powered; (3) both charging and discharging are accomplished with high efficiency(i.e., less power is dissipated in the circuit elements, with the result that average power consumption is lower, circuit size can be physically smaller, and operating temperature can be lower); (4) only two switching elements are required for charging and discharging the device, and both switches are referenced to ground; (5) both switches operate so as to eliminate capacitive switching losses; and (6) EMI (electromagnetic interference) production is minimized.

These and other features, objects and advantages of the invention will become apparent to those persons skilled in the art upon reading the details of the invention as more fully described below.

### BRIEF DESCRIPTION OF THE DRAWINGS

The invention is best understood from the following detailed description when read in conjunction with the accompanying schematic drawings. To facilitate understanding, the same reference numerals have been used (where practical) to designate similar elements that are common to the drawings. Included in the drawings are the following:

FIG. 1 is a schematic representation of a standard flyback converter circuit commonly employed in prior art power supplies;

FIG. 2 is a schematic representation of a flyback converter circuit of the present invention;

FIG. 3 is a schematic representation of a switching device of the present invention which may be incorporated into the flyback converter circuits of the present invention;

FIG. 4 is a block diagram of the exemplary control logic that can be implemented with the soft switching operation of the flyback converter circuits of the present invention;

FIG. 5 illustrates the flyback converter circuit of FIG. 2 implemented with control circuitry of the present invention which enables synchronous on-off cycling and continuous mode operation of the switching components of the flyback circuit; and

FIGS. 6A-6C illustrate timing diagrams for several operational modes of the circuit of FIG. 2.

Variation of the invention from that shown in the figures is contemplated.

### DETAILED DESCRIPTION OF THE INVENTION

Various exemplary embodiments of the invention are described below to illustrate broadly applicable aspects of the present invention. In particular, a number of flyback converter circuits for powering high-frequency devices are provided which achieve the high-efficiency and minimized power loss objectives of the present invention. Additionally, exemplary circuitry for use as switching components to be incorporated in the flyback circuits is also described, followed by a discussion of exemplary control logic for timing the switching components. As the totality of the following description reveals, the present invention overcomes many of the shortcomings of prior art power supplies for high-frequency applications.

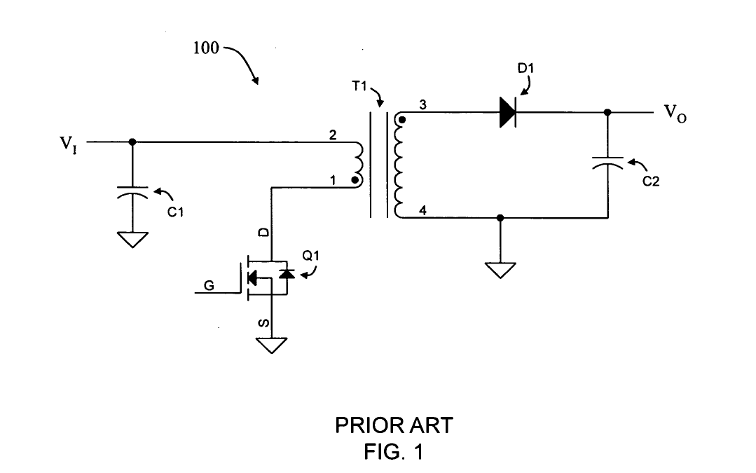

The present invention utilizes a power topology called a “flyback” converter. The purpose of the flyback topology is DC to DC conversion: power is drawn from a source at one DC voltage, and delivered to a load at a different DC voltage. Standard flyback converter circuits, such as circuit 100 illustrated in FIG. 1, have long been used in many known power supplies to “step up” a lower input voltage V_{I} to a higher output voltage V_{O}. The basic components of flyback circuit 100 include capacitors C1 and C2, transformer T1, transistor Q1 and diode D1; for typical applications of the standard flyback circuit, a load element (not shown) is connected to V_{O}, drawing current from capacitor C2. These components make up the “power train” of the circuit in that they are directly involved in the transfer of energy from the input voltage V_{I} to the output voltage V_{O}. For purposes of this discussion, it is assumed that the values of capacitors C1 and C2 are so large as to render the input and output voltages approximately constant over a period of operation. The flyback transformer TI differs slightly from a standard transformer in that it is designed to store a predetermined amount of energy. (In a standard transformer, the storage of energy is undesirable.) This energy storage capability is usually implemented by leaving an air gap in the transformer core; the volume of the gap and the intensity of the magnetic field in the air determine the amount of energy storage. The transistor Q1 is depicted as a MOSFET, but can be any controlled semiconductor device (e.g., a BJT, IGBT, JFET, and other similar components, etc.)

To understand the operation of circuit 100, a periodic steady-state condition is assumed (i.e., the values of circuit variables are the same at the beginning and end of the period). The onset of conduction in transistor Q1 is caused by raising the gate-source voltage (i.e., across terminals G and S) at the beginning of a period, although transistor conduction may be configured to occur at any time within the functional period. With transistor Q1 “on”, the full input voltage V_{I} is applied to the primary winding (i.e., across terminals 1 and 2) of transformer T1. The polarity of the transformer windings and the orientation of diode D1 are such that the secondary winding (i.e., across terminals 3 and 4) of transformer T1 cannot conduct current while transistor Q1 is on. Hence, current in the primary winding increases linearly with time, and as such, functions as an inductor. Transistor Q1 remains on for a period of time determined by a control circuit (not shown). At the end of this time, the gate-source voltage of transistor Q1 is returned to zero, and transistor Q1 ceases to conduct current. This abrupt turn-off of transistor Q1 while current is flowing in transformer T1 causes the voltage at terminal 1 of the transformer to rise. The secondary voltage on terminal 3 of transformer T1 also rises, scaled up by the turns ratio of the transformer. When this secondary voltage slightly exceeds the output voltage V_{O}, diode D1 begins to conduct, enabling current to flow to the output and thereby transferring energy previously stored in transformer T1 to the capacitor C2, where it is made available to the load. Meanwhile, diode D1 prevents the current from reversing direction. Thus, as energy is transferred to the output capacitor, the transformer current decreases. Through the nature of transformer operation, this also serves to limit the voltage on the primary winding and transistor Q1, thereby protecting them from damage and degradation. Transistor Q1 may then be turned on again either before or after the secondary current reaches zero.

The amount of power transferred from the source V_{I} to the load V_{O} can be controlled by varying the duty cycle (i.e., the ratio of on-time to off-time) of transistor Q1. Typically a feedback control circuit (described below) will sense the output voltage V_{O}, and adjust the duty cycle of transistor Q1 to maintain that voltage at a predetermined set point. However, there are still inefficiencies (i.e., switching losses) in the on-off cycling of transistor Q1 resulting in significant losses of power on the output side of the circuit. In a fast switching circuit, e.g., where the switching frequency of Q1 is about 25 kHz or greater, the energy dissipated in the transistor switch at every turn-on can result in a substantial amount of power dissipation.

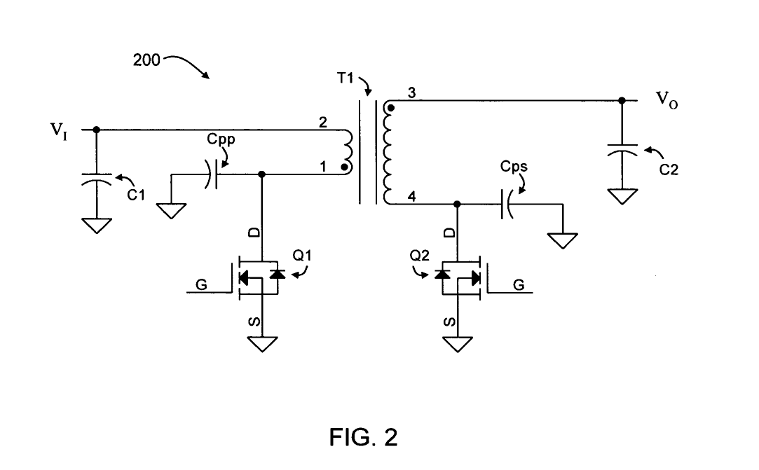

FIG. 2 illustrates a schematic of a flyback circuit 200 of the present invention which overcomes switching losses of standard flyback circuits, and which provides bi-directionality (i.e., charging and discharging) with the use of two switches rather than just one. Bidirectional operation of circuit 200 is achieved with the addition of a secondary transistor switch Q2, an active MOSFET device. Switch Q2 obviates the need for the secondary rectification diode required in the standard flyback circuit 100 of FIG. 1 as power MOSFETs contain a diode internally as an integral part of the fabrication process. Other types of transistor and diode combinations may be used, provided that both the transistor and diode are capable of withstanding the voltages present on the output side of circuit 200. The primary switch Q1 in FIG. 2 also includes a parallel diode incorporated in the same manner as the secondary switch Q2. As such, a symmetrical circuit arrangement 200 (about transformer T1) is provided; however, the polarities of the respective transistor windings are reversed from each other.

The operating cycle of flyback converter circuit 200 begins by turning on transistor switch Q1, such that the input voltage V_{I} is impressed across the primary winding of the transformer T1. While transistor Q1 is on, no current flows in the secondary side of the transformer. (Hence, while the flyback transformer is commonly referred to as a “transformer”, it is more accurately an inductor with multiple windings.) The voltage across the primary winding causes an increasing current in the transformer inductance which, when the current has built up to a sufficient level, is interrupted by turning off transistor Q1.

The energy that is built up in the inductance of transformer T1 has to find an outlet when transistor Q1 is turned off. The immediate effect of this high voltage “kick” across the transformer windings is to increase the voltage across transistor Q1 and to decrease the voltage across the secondary side switching element Q2. Then, transistor Q2 is turned on when its parallel diode begins to conduct. While transistor Q2 is held on, the current through transformer T1 will decrease, proceeding past zero to a negative value. As such, energy is removed from output capacitor C2 and stored in transformer T1. (Note that full charging or discharging of capacitor C2 is not intended to occur over one flyback cycle, but rather over many cycles occurring at a frequency much higher than the desired charge/discharge frequency.)

At this point, flyback circuit 200 is operating in the reverse direction. When transistor Q2 is turned off, the stored energy within the transformer is transferred to input capacitor C1. Thus, circuit 200 allows bidirectional power transfer. The average value of the current in transformer T1, determined by the timing of transistor switches Q1 and Q2 (which in turn is dictated by control circuitry), sets the direction of power flow.

In addition to providing bi-directional operation, the two-switch approach allows for “soft switching”. Under typical “hard-switched” circuit operation, a transistor is turned on when there is voltage across it. This discharges any parasitic capacitance at the switching node, symbolized in FIG. 2 as capacitors Cpp and Cps on the primary and secondary sides, respectively, of transformer T1. As mentioned above, this can lead to significant power losses in the transistor, particularly on the high-voltage/secondary side of the circuit. However, under “soft-switched” operation, the parasitic capacitance on the switching node is discharged from the transformer current before the respective transistors are turned on. Thus, the voltage across a transistor when turned on is close to zero, thereby minimizing any power losses. Additionally, the parasitic capacitance can reduce losses during the turn off of the switch; as such, it may be desirable to add more capacitance in parallel with the parasitic capacitance Cpp and/or Cps.

In describing the operation of this soft switching scheme, a steady state operating condition is assumed. Starting with transistor Q1 in the on state, there is a build up of current in transformer T1. When transistor Q1 is switched off, the voltage on its drain pin D increases. (It is assumed that transistor Q1 can be switched off fast enough to reduce its current to zero before the voltage rises significantly on its drain pin.) In this way, the inherent parasitic capacitance, symbolized by capacitor Cpp, prevents an excessively fast rise of voltage across transistor Q1, so that its turn-off switching losses will be essentially zero.

After turning off transistor Q1, the voltage across it rises, exceeding input voltage V_{I} on capacitor C1. Meanwhile, the voltage on transistor Q2 begins to decrease. If the voltage across transistor Q2 falls to zero and proceeds to drop below ground potential, the internal diode of transistor Q2 will become active and limit the negative-going voltage to the diode drop of transistor Q2. The voltage across transistor Q2 is then effectively “clamped” to ground (or slightly less). If transistor Q2 is now switched on, it will not be subject to turn-on switching losses. However, if the stored energy in transformer T1 is not sufficient to bring the voltage across transistor Q2 to zero, transistor Q2 will not turn on and no net energy will be delivered to capacitor C2. The latter situation may be obviated by ensuring adequate energy storage in T1, as detailed below.

By means of novel control circuitry, discussed in detail below, transistor Q2 can be made to remain on until the direction of current flow through its drain pin D and transformer T1 reverses. With transistor Q2 turned on for a sufficient length of time, the reverse flow of current builds energy in transformer T1 and begins to discharge capacitor C2. With proper timing implemented by the control circuit, transistor Q2 is switched off. Similar to the function of the parasitic capacitance on the primary side of the circuit (Cpp), the parasitic capacitance on the secondary side of the circuit (Cps) prevents an excessively fast rise of voltage across transistor Q2, so that turn-off switching losses will be essentially zero. Again, in this way, the subject power circuit utilizes the inherent parasitic capacitance on the secondary side of the circuit to positively effect the turn-off transition of transistor Q2.

Now, the flyback action is made to take place in the reverse direction. With the voltage across transistor Q1 decreasing, transistor Q1 may be turned on at zero volts with no turn on switching loss and the transformer current is discharged into capacitor C1. This cycle can repeated indefinitely resulting in near zero switching losses, regardless of the amount of stray capacitance in the circuit.

Such “soft switching” may be applied to both the primary and secondary transistor switches Q1 and Q2, respectively, although it is more critical on the high voltage side. An additional advantage of this type of switching is the ability to control edge speeds (i.e., the rate of change of voltage at the drains of Q1 and Q2) to reduce electromagnetic interference (EMI) generation. This removes the need for circuit snubbers (additional circuit elements whose sole purpose is to counter non-ideal circuit effects), which are used in many conventional circuits to minimize ringing due to circuit parasitics. Yet another benefit of the circuit topology of FIG. 2 is that both transistor switches Q1 and Q2 are referenced to ground, removing the need for transformer coupled gate drive circuitry which adds common-mode voltage to the gate drive signal, and allowing switches Q1 and Q2 to be driven with low-voltage signals.

In the operation of circuit 200 just described, there is a need to transfer some energy in each direction on every cycle in order to trigger the switching operation.

During the charging portion of the cycle, the parasitic capacitance Cps must be discharged from the transformer inductance into load capacitor C2. The additional energy required to do this must be stored in transformer T1, which is accomplished by increasing the current through the primary side of circuit 200. Similarly, during discharge, parasitic capacitance Cpp must be discharged from the transformer inductance into capacitor C1, again requiring energy storage in T1. This requires higher current levels in the transformer, and in turn may cause additional energy losses in the circuit. However, this may be mitigated by keeping the switching node capacitances as low as possible.

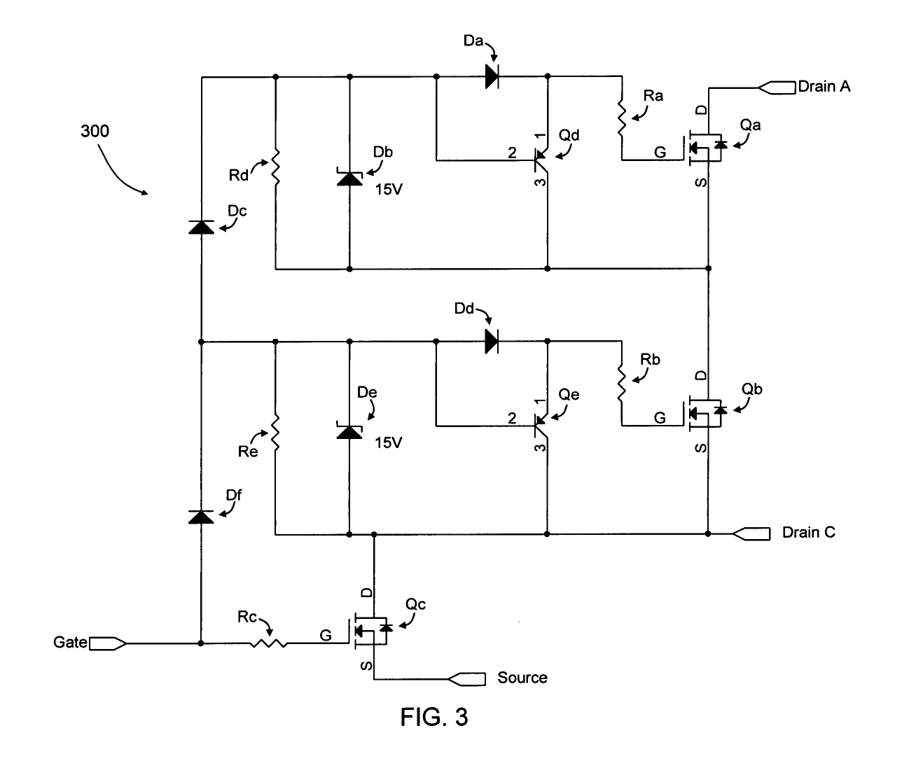

As mentioned above, transistor Q2 is required to withstand high-voltages for most EPAM applications. Because appropriate MOSFET devices are not readily available for such applications, discrete lower-voltage components connected in series may be used to form an effective high-voltage equivalent component. As such, circuit 300 of FIG. 3 is used to serve the function of the secondary switching component (transistor Q2) in FIG. 2.

Circuit 300 includes a series or cascading arrangement of MOSFET transistors QA, QB and QC, which, along with associated components (e.g., resistors, diodes, transistors, capacitors (not shown) and other components), are referred to as stages for purposes of this discussion. This arrangement provides a composite high-voltage switching device 300 which is essentially a three-terminal transistor having gate (“Gate”), source (“Source”), and drain (“Drain A”) connections. More specifically, the voltage rating of circuit 300 is equivalent to the sum of the voltage ratings of each stage. An optional terminal, Drain C, may be provided for monitoring the switch's on/off states by a control circuit, discussed in greater detail below.

For purposes of describing the operation of high-voltage switch circuit 300, it is assumed that the Source terminal is connected to ground. As such, output transistor Q_{C} can be driven in a straightforward manner with the Gate signal. Resistors R_{A}, R_{B} and R_{C} are damping resistors in each gate circuit to prevent oscillation when driving respective output transistors Q_{A}, Q_{B} and Q_{C} in a linear mode. However, it is noted that these resistors may not be necessary in a preferred flyback circuit with lossless switching. Diodes D_{C} and D_{F} are cascaded high-voltage diodes designed to match output transistors Q_{A}, Q_{B} and Q_{C} in voltage-withstanding characteristics.

Under soft switching operation, a high drive level is applied to the Gate input (typically about 10 to about 15 volts) when the Drain A voltage (and hence the source voltage on all output transistors Q_{A}, Q_{B} and Q_{C}) is near ground potential. This forces a positive voltage on the gates of transistors Q_{A} and Q_{B} as well as Q_{C}. The output transistors Q_{A}, Q_{B} and Q_{C} are then in the low impedance state. This represents an ON condition for switch 300.

When the Gate input is forced near ground, all output transistors Q_{A}, Q_{B} and Q_{C} switch to the off state. To speed up the on-off transition, standard transistors Q_{D} and Q_{E} are used, in conjunction with R_{D} and R_{E}, to pull charge out of the gates of output transistors Q_{A} and Q_{B}. Diodes D_{B} and D_{E} are added as protection components to prevent possible voltage spikes from damaging output transistors Q_{A} and Q_{B}. It is also important to note that the avalanche diodes that are internal to the output transistors Q_{A}, Q_{B} and Q_{C} will protect the transistors from over-voltage conditions during turn-off. Conversely, when raising the Gate signal to a high level, these same avalanche diodes will protect each output transistor during turn-on, even if the voltage across all output transistors is not zero volts. Normally, however, the avalanche characteristics of the internal diodes will not be required for the preferred “lossless” switching operation mode.

While the exemplary high voltage switching circuit 300 of FIG. 3 is illustrated having three stages, any number of stages, either more or less, may be employed depending upon the required voltage output. Those skilled in the art will recognize that when adding or eliminating stages, certain other modifications (in addition to the addition or elimination of the basic stage components) may have to be made to maintain performance characteristics.

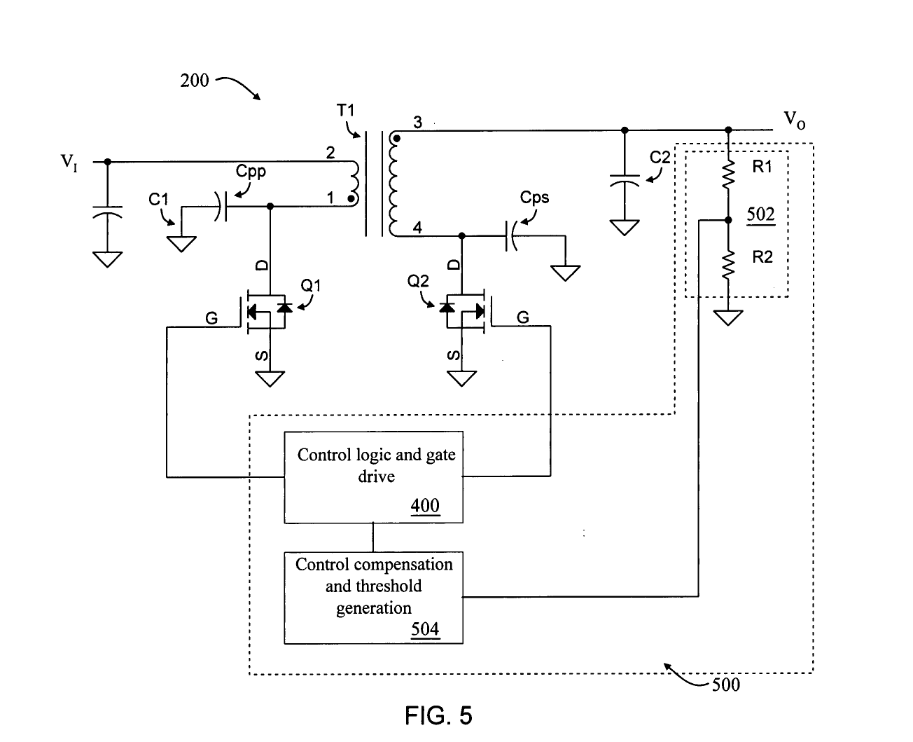

In order to effectively implement the “soft switching” scheme of the present invention to ensure minimum energy loss (from the distributed capacitance in the transformer T1, capacitance of the transistors Q1, Q2, and any other stray capacitance) in the flyback converter circuits of the present invention, a properly timed, synchronous operation of the circuits' switches (Q1 and Q2) must be implemented. The sequence of properly timed transistor switches is as follows: when the drain voltage of switch Q1 falls substantially below the maximum voltage across it, switch Q1 is turned on; the current through switch Q1 reaches the threshold value (as determined by a control circuit, such as circuit 504 of FIG. 5), at which time switch Q1 is turned off; when the drain voltage of switch Q2 falls substantially below the maximum voltage across it, switch Q2 is turned on; and the current through switch Q2 reaches the threshold value, at which time switch Q2 is turned off. This operation cycle is repeated as desired. In one embodiment, the turning on of each of the switching elements occurs when the voltage across the respective switching element is ideally about (just above or below) zero volts.

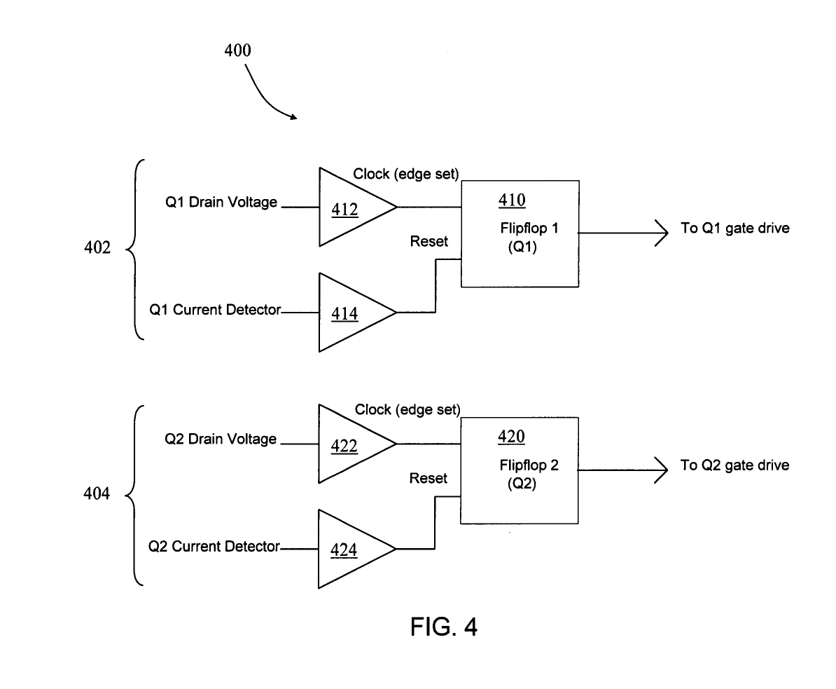

As mentioned above, the on-off timing of the switches may be dictated by control circuitry. FIG. 4 shows a block diagram of exemplary control logic 400 of the present invention that may be used to implement the soft switching operation described above with respect to the flyback circuit of FIG. 2.

The control logic 400 includes two sub-circuits 402, 404 where one sub-circuit translates the transistor voltage and current state into a gate drive signal for each transistor switch Q1, Q2 of FIG. 2, respectively. Note that if circuit 400 is used in place of transistor Q2, it may be advantageous for comparator 422 to use the voltage at Drain C rather than Drain A as an input, as the voltages encountered will be lower. Each sub-circuit 402, 404 operates using a digital flip-flop circuit 410, 420, respectively, in conjunction with analog comparator circuits, namely voltage and current comparators 412, 414 (with flip-flop 410) and voltage and current comparators 422, 424 (with flip-flop 420). Each of the voltage comparators 412, 422 triggers a negative-going edge at the “clock” input (i.e., comparator output) when the corresponding transistor's (Q1, Q2) drain voltage approaches zero volts. (It is the high to low transition (edge) at the clock input rather than the static voltage level that sets the output high.) This results in a logic high output level on the corresponding flip-flop 410, 420. When a flip-flop's output is high, its corresponding transistor switch Q1, Q2 is “on”. (Some additional gate drive circuitry between each flip-flop and its associated transistor may be necessary to ensure fast turn-on and turn-off with appropriate voltage levels.)

The increasing current through the transistor switches Q1, Q2 is monitored with current comparator/sensing circuits 422, 424, respectively. Once a predetermined threshold current level in the transistors Q1, Q2 is reached, the corresponding flip-flop 410, 420 is reset (i.e., the flip-flop receives a logic high input to the reset pin). This in turn results in a logic low output on the corresponding flip-flop. Thus, the corresponding transistor Q1, Q2 is turned off, and the next portion of the switching cycle is initiated as described above.

It is possible to deviate from this sequence, due to parasitic coupling between circuits or other undesired effects, causing erroneous operation. Provisions can be made with additional circuits to avoid undesirable logic states or sequences. For example, resetting flip-flop 420 whenever the output on flip-flop 410 is high avoids turning on both transistors Q1 and Q2 at the same time. Also, while the above-described sequence is applicable to the situation where the flyback circuit has been operating (i.e., previously started up), it does not necessarily apply to a start-up mode.

For start-up, an oscillator may be implemented that will initially turn on transistor Q1 if no activity is detected for a significant time period, but will otherwise be inactive during operation of the flyback circuit.

Those skilled in the art will appreciate that the control circuitry and components just described for operating the subject flyback circuits are only exemplary, as there are many other means, such as microprocessors programmed according to the principles of the present invention, which may perform the desired control functions.

Whether by means of the control circuitry 400 of FIG. 4 or through other control means, control of the flyback circuit 200 is accomplished through the choice of turn-off current threshold values for transistors Q1 and Q2. For example, setting a high current threshold value for transistor Q1 and a low current threshold value for transistor Q2 results in a net transfer of energy from source capacitor C1 to load capacitor C2, thereby charging capacitor C2. Conversely, a low current threshold value for transistor Q1 and a high current threshold value for transistor Q2 transfers energy from load capacitor C2 to source capacitor C1, thereby discharging capacitor C2. If similar current threshold levels are set for transistors Q1 and Q2, an idling mode can be implemented in which no net energy is transferred over the full cycle of operation. The transition between modes is smooth, as circuit operation is fundamentally the same in each case. However, enough energy must be transferred over each half-cycle to trigger the next switching event. Thus, for practical purposes, the current threshold levels must have nonzero minimum values; otherwise the circuit fails to deliver enough energy to force the next switch turn-on.

In order to obtain regulation of the output voltage at a desired level, closed-loop control of the flyback converter circuit may be implemented. FIG. 5 illustrates an exemplary control circuit 500 coupled to the flyback converter circuit 200 of FIG. 2. Control circuit 500 includes a voltage divider circuit 502 comprising resistors R1 and R2 coupled to the output voltage V_{O} of circuit 200. The voltage divider 502 scales down the output voltage to a practical value which is in turn provided as an input to a control compensation/threshold generation circuit 504 which compares the scaled-down output voltage to a user-selected reference voltage. An error signal based on the difference between the output and reference voltages is generated and used to set the current threshold values that govern turn-off of transistor switches Q1 and Q2. Various threshold generation circuits may be employed for setting these threshold values, several of which are described below. Circuit 504 may further include circuitry to condition the signals representative of the current threshold values to provide the desired static and dynamic response. The current threshold signal(s) are provided as inputs to the control logic/gate drive circuit 400 which provides the signals to the respective gate G of each of transistors Q1 and Q2 as described above.

One variation of a threshold current generation circuit suitable for use with the present invention involves permanently setting transistor Q1's threshold current to its maximum value whereby only the threshold current value for transistor Q2 need be adjusted. By making transistor Q2's threshold value large or small in relation to the fixed threshold value for transistor Q1, the desired charging, discharging and idling of the flyback circuit can be implemented.

Another scheme for threshold current generation sets the threshold level for transistor Q1 and then inverts this signal to be used as the threshold value for transistor Q2. In this manner, when one threshold is high, the other is low, and vice-versa. This improves the rate of discharge over the previous scheme, and may also reduce resistive losses.

Yet another scheme develops separate signals for threshold values for transistors Q1 and Q2, by using separate compensation circuits. With this scheme, only one of these signals is active at a given time. For example, in charge mode, only transistor Q1's threshold signal is applied to the control logic, while transistor Q2 operates with a fixed minimum value threshold. Conversely, in discharge mode, transistor Q1 operates with a fixed minimum threshold, while transistor Q2's signal is applied. A comparison of the error signal with a reference signal, as described above, determines whether to run in charge or discharge mode.

A variation of this scheme allows the minimum threshold values used for both transistors Q1 and Q2 to be adjusted rather than being fixed. The minimum threshold values are then based on the system input and output voltages V_{I} and V_{O}, respectively. For example, if the voltage on load capacitor C2 is at its maximum, the threshold current for transistor Q1 must be large to ensure the charging of capacitor Cps and the subsequent turn-on of transistor Q2. This represents the worst-case condition for transistor Q1's threshold current, which is used as the minimum value under a fixed-minimum scheme. However, when the voltage on load capacitor C2 is low, charging of capacitor Cps requires less energy, and transistor Q1's threshold current can be reduced below the worst-case value. This allows circulating currents to be scaled back when possible, reducing overall resistive losses.

Under all of the control schemes described above, the operation frequency of the flyback circuit is determined by the input and output voltages, the inductance of the flyback transformer and the current threshold levels, and does not depend upon an external oscillator. However, fixed frequency schemes may also be possible.

With the various control circuitry and transistor timing schemes of the present invention described above, each switching element (transistor Q1, Q2) of the subject flyback converter circuit is independently controlled. As previously explained, such independent control of the flyback circuit's switching elements is advantageous to providing “soft switching” operation with minimum energy loss. Note that the transformer current will be continuous even though its value may reach (or pass through) zero amps. This means that at least one or the other of the switching elements (Q1 or Q2) must be “on” at any given time, with the exception of the brief period during voltage transitions when both switching elements may be “off”; however, this transition time is nominal relative to the operating frequency of the circuit and does not affect “continuous” mode operation.

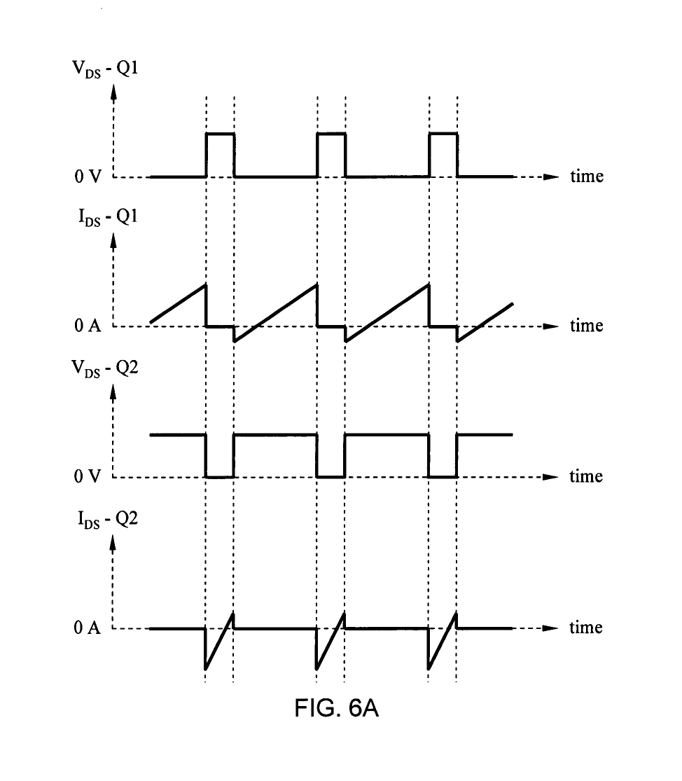

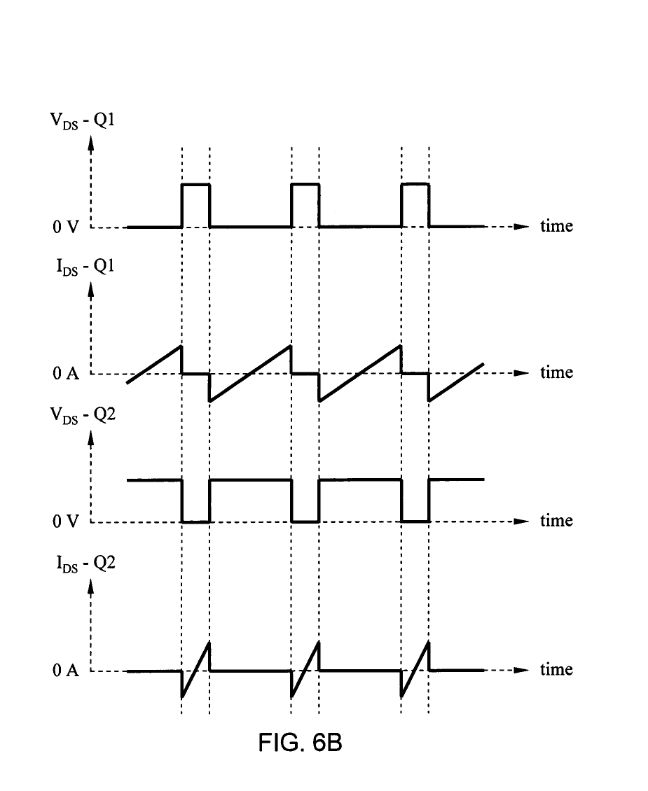

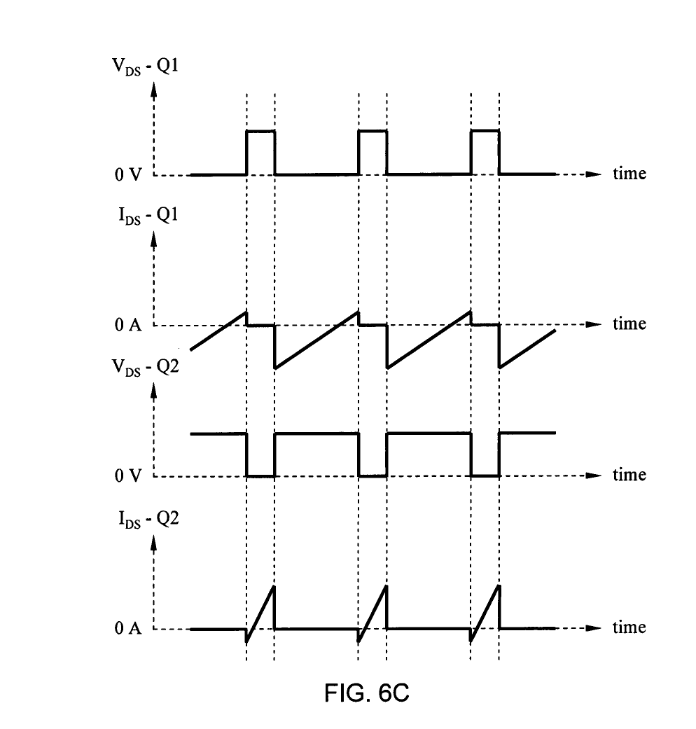

Various modes of operation of the subject flyback converter circuit will now be described with reference to the transistor switch timing diagrams of FIGS. 6A-6C.

In all modes described below, it is assumed that the flyback circuit has been in operation, i.e., is not in start-up mode In each figure, the peak voltages across Q1 and Q2 depend on the input voltage, output voltage and transformer turns ratio, and the peak currents in Q1 and Q2 are set by the chosen current threshold values.

FIG. 6A illustrates voltage and current timing diagrams for transistor switches Q1 and Q2, respectively, when flyback circuit 200 is in a charging mode where power is transferred from the input (low-voltage) side to the output (high-voltage) side of the circuit. Note that the average current in Q1 is greater than zero, while the average current in Q2 is less than zero; this is characteristic of the charging mode of operation.

FIG. 6B illustrates voltage and current timing diagrams for transistor switches Q1 and Q2, respectively, when flyback circuit 300 is in an idling mode where an equal amount of power is transferred from the input (low-voltage) side to the output (high-voltage) side of the circuit, and from the output side to the input side of the circuit. Note that average current in both Q1 and Q2 is zero, indicating no net energy transfer from input to output. This mode of operation would typically be seen when the output load does not require any power, as can be the case for a capacitive actuator holding a fixed position.

FIG. 6C illustrates voltage and current timing diagrams for transistor switches Q1 and Q2, respectively, when flyback circuit 300 is in a discharging mode where power is transferred from the output (high-voltage) side to the input (low-voltage) side of the circuit. In contrast to FIG. 6A, note that average current in Q1 is less than zero, while average current in Q2 is greater than zero; this is characteristic of the discharging mode of operation.

### EXAMPLE

An exemplary application of the power circuit of FIG. 2 involves charging a 1 nF capacitor (C2) to 2000 V (V_{O}) in 2.5 msec, with a 10 V input supply (V_{I}). Using Cpp and Cps capacitors having values of 500 pF and 50 pF, respectively, and a selected switching frequency of 25 kHz. The flyback transformer (T1) may have an inductance (as measured from the primary side) of 82 uH, and a primary-to-secondary turns ratio of 1:50. Capacitor C1 may have a value of 190 uF or greater. The peak voltage across transistor Q1 is about 50V, while the worst-case peak current in transistor Q1 during the charging cycle is about 3.9 A, and the minimum current in transistor Q1 is about 25 mA. The peak voltage across transistor Q2 is about 2500 V, while the maximum and minimum currents in transistor Q2 is about 500 nA to about −78 mA, respectively.

Methods associated with the subject power and control circuits are contemplated in which those methods are carried out with high-frequency devices. In one particular embodiment, the method involves charging and discharging a device such as an EPAM-based actuator. The methods may be performed using the subject circuits and systems or by other means. The methods may all comprise the act of providing a suitable circuit, device, system, etc. Such provision may be performed by the end user. In other words, the act of “providing” merely requires the end user obtain, access, approach, position, set-up, activate, power-up or otherwise act to provide the requisite object used in the subject method. Likewise, the various acts of mechanical and/or electrical actuation are included in some of the subject methods; and in others, power profiles, switch timing, power monitoring and other aspects of power control are considered.

Yet another aspect of the invention includes kits having any combination of devices described herein—whether provided in packaged combination or assembled by a technician for operating use, instructions for use, etc. A kit may include a power supply including a subject flyback converter circuit with or without the above-described control circuitry. The kit may further include various other components for use with the power supplies including mechanical or electrical connectors, etc. The subject kits may also include written instructions for use of the power supplies and/or their assembly.

These instructions may be printed on a substrate, such as paper or plastic, etc.

As such, the instructions may be present in the kits as a package insert, in the labeling of the container of the kit or components thereof (i.e., associated with the packaging or sub-packaging) etc. In other embodiments, the instructions are present as an electronic storage data file present on a suitable computer readable storage medium, e.g., CD-ROM, diskette, etc. In yet other embodiments, the actual instructions are not present in the kit, but means for obtaining the instructions from a remote source, e.g., via the Internet, are provided. An example of this embodiment is a kit that includes a web address where the instructions can be viewed and/or from which the instructions can be downloaded. As with the instructions, this means for obtaining the instructions is recorded on suitable media.

As for other details of the present invention, such as the types of devices that may be powered by the subject power circuits/supplies, these may be appreciated in connection with the above-referenced patents and publications as well as those generally known or appreciated by those with skill in the art. The same may hold true with respect to method-based aspects of the invention in terms of additional acts as commonly or logically employed.

The invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. Any number of the individual parts or subassemblies shown may be integrated in their design. Such changes or others may be undertaken or guided by the principles of design for assembly. In addition, where a range of values is provided, it is understood that every intervening value, between the upper and lower limit of that range and any other stated or intervening value in that stated range is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in the appended claims, the singular forms “a,” “an,” “said,” and “the” include plural referents unless the specifically stated otherwise. In other words, use of the articles allow for “at least one” of the subject item in the description above as well as the claims below. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Without the use of such exclusive terminology, the term “comprising” in the claims shall allow for the inclusion of any additional element—irrespective of whether a given number of elements are enumerated in the claim, or the addition of a feature could be regarded as transforming the nature of an element set forth n the claims. Stated otherwise, unless specifically defined herein, all technical and scientific terms used herein are to be given as broad a commonly understood meaning as possible while maintaining claim validity.

In all, the breadth of the present invention is not to be limited by the examples provided. That being said, we claim:

1. A power circuit comprising:
means for receiving a voltage input,
a transformer coupled between the voltage input and an output load,
a primary switching element coupled to a primary side of the transformer and a secondary switching element coupled to a secondary side of the transformer; and
a means for controlling the on-off operation of the primary and secondary switching elements, wherein the timing of the operation provides lossless switching and bidirectional power flow through the circuit.

2. The power circuit of claim 1 is adapted for powering a capacitive device wherein operation of the switching elements provides charging and discharging of the device.

3. The power circuit of claim 2 wherein the capacitive device is an EPAM actuator.

4. The power circuit of claim 1 wherein each switching element comprises a semiconductor device.

5. The power circuit of claim 4 wherein the semiconductor device is selected from the group comprising a MOSFET, BJT, IGBT and JFET.

6. The power circuit of claim 1 wherein the means for controlling comprises means for measuring the voltage across and the current through each of the switching elements.

7. The power circuit of claim 6, further comprising means for timing the on-off operation of the switching elements, wherein the timing is derived from the switching element voltages and currents.

8. The power circuit of claim 1, wherein at least one of the switching elements comprises a plurality of serially connected stages, each stage having a voltage rating, wherein the voltage rating of the switching element is the sum of the stage voltage ratings.

9. The power circuit of claim 8, wherein each serially connected stage comprises a semiconductor device.

10. A method of powering a device, comprising:
providing the power circuit of claim 1 and applying a voltage input to the power circuit;
(a) switching the primary switching element on when the voltage across the primary switching element is substantially less than a maximum voltage across the primary switching element thereby applying the voltage input to the primary side of the transformer and increasing the voltage across the secondary switching element;
(b) switching the primary switching element off thereby decreasing the voltage across the secondary switching element;
(c) switching the secondary switching element on when the voltage across the secondary switching element is substantially less than a maximum voltage across the secondary switching element;
(d) switching the secondary switching element off thereby decreasing the voltage across the primary switching element; and
repeating (a) through (d) as desired

11. The method of claim 10, wherein the switching on of each of the switching elements occurs when the voltage across the respective switching element is about zero volts.
